(19) United States
(12) Patent Application Publication
(10) Pub. No.: US 2018/0129015 A1
(43) Pub. Date: May 10, 2018

(54) LIGHT REFLECTING DEVICES INCORPORATING COMPOSITE REFLECTING STRUCTURES

(71) Applicant: SolarReserve Technology, LLC, Santa Monica, CA (US)

(72) Inventors: Christian Gregory, La Crescenta, CA (US); Adam Green, Los Angeles, CA (US); Richard Ehrgott, Topanga, CA (US)

(21) Appl. No.: 15/569,674

(22) PCT Filed: Apr. 28, 2016
(86) PCT No.: PCT/US16/29761

§ 371 Date: Oct. 26, 2017

Related U.S. Application Data
(60) Provisional application No. 62/153,723, filed on Apr. 28, 2015.
(60) Provisional application No. 62/153,716, filed on Apr. 28, 2015.
(60) Provisional application No. 62/211,376, filed on Aug. 28, 2015.

(51) Int. Cl. G02B 7/18; G02B 7/183; G02B 19/00; H02S 40/22

(52) U.S. Cl. CPC G02B 7/181; G02B 7/183; G02B 19/0042; F24J 2002/0076; H02S 40/22; F24J 2/02; G02B 19/0019

(57) ABSTRACT

In illustrative modes of practice, heliostat devices integrate light reflecting panels with a composite supporting structure that helps to provide the resultant assembly with structural integrity and stiffness. Light reflecting panels are coupled to the supporting, composite structure by a plurality of flexible connecting elements. Advantageously, the composite approach of the present invention effectively separates structural and thermal compensation functions. Specifically, the composite support structure helps to provide desired structural properties. In the meantime, the flexible connecting elements couple the top, light reflecting panel to the support structure in a manner that helps to isolate the top, light reflecting panel from thermal stresses that otherwise could cause undue slope errors.

### PRIORITY

This application claims the benefit of U.S. Provisional Patent Application Ser. No. 62/153,723, filed on Apr. 28, 2015; U.S. Provisional Patent Application Ser. No. 62/153,716 filed on Apr. 28, 2015; and U.S. Provisional Patent Application Ser. No. 62/211,376, filed on Aug. 28, 2015, which are incorporated herein by reference in their entirety for all purposes.

### FIELD OF THE INVENTION

The present invention relates to light reflecting devices used for redirecting light to a target. More specifically, the light redirecting devices incorporate composite reflecting structures in which light reflecting surfaces are more stable and less prone to slope errors that might otherwise result from temperature changes.

### BACKGROUND

Many useful devices incorporate features that reflect incident light. Examples of such devices include mirrors, heliostats, siderostats, coelostats, trough reflectors, dish reflectors, solar trackers, and other similar devices that are useful in systems such as telescopes, solar panels, solar power plants or systems, and the like. In all such systems, it is important that the light reflecting surface is stable for good performance over a wide range of temperatures. Due to factors such as differences in the coefficients of thermal expansion among components, temperature changes can cause a light reflecting surface to deviate from its design, undermining performance.

Solar power plants or systems that collect and concentrate solar energy onto one or more centralized targets are well known in the art. The concentrated solar energy often is used to directly or indirectly produce electricity and/or heat. Direct conversion, often referred to as concentrating photovoltaics (CPV) occurs in some modes of practice when photovoltaic cells (also known as solar cells) serve as the target(s) to convert incident, concentrated solar energy into electricity using photovoltaic effects. Indirect conversion, often referred to as Concentrating Solar Power (CSP) occurs when the thermal energy of the concentrated solar energy is used in some modes of practice to heat a working fluid, or a sequence of working fluids, that in turn drives machinery such as a turbine system to generate electric power. Working fluids include steam, oil, molten salt, or the like.

U.S. Pat. Nos. 8,833,076; 8,697,271; 7,726,127; 7,299,633; and U.S. Pat. Pub. No. 213/0081394 A1 describe systems in which solar energy heats molten salt to store the thermal energy. The molten salt can store the heat for extended periods of time for later use on demand. The molten salt thus functions as a thermal battery that is charged by the sun. The molten salt in turn is used in illustrative modes of practice to heat steam that drives a turbine to generate electricity. After heating the steam, the molten salt cools down but is readily re-heated, or re-charged, by again using concentrated solar energy. Molten salt can be heated, used, and recharged this way many times without being consumed to any significant degree. Facilities that use molten salt in this fashion are projected to have lifespans extending for decades.

CSP systems typically rely on a field of light reflecting devices that track, reflect, and collectively concentrate incident sunlight onto a solar receiver. Many types of light reflecting devices are known. Examples include those that incorporate plane mirrors, parabolic dishes, faceted surfaces, trough concentrators, and the like. A CSP system often may use hundreds or even thousands of light reflecting devices to concentrate solar energy onto one or more common targets.

Light reflecting surfaces, e.g., mirrors in many instances, are a fundamental component of the heliostat devices used in CSP plants. The primary function of the mirrors is to reflect sunlight onto a target where the resultant concentrated sunlight can then be converted into other forms of useful energy, such as electricity or heat. Mirrors may have a variety of shapes, and many shapes are suitable to redirect sunlight onto a desired target. As examples of shapes, mirrors may be flat, curved in two dimensions, curved in three dimensions, faceted, and the like. Some mirrors may re-direct sunlight via retroreflective characteristics, Fresnel characteristics, or the like.

The light redirecting components, such as mirrors, often are supported by a suitable substrate structure so that the mirrors substantially maintain their shape without undue sagging, thermal deformation, or shape deformation as the mirrors articulate and are impacted by wind, moisture, age, temperature changes, and other surrounding factors. An important factor that affects energy delivery over time is any deviation (also known as slope error) between the actual mirror shape and the intended mirror shape. A goal is to limit this slope error to desired tolerances. The degree to which slope errors are tolerated is referred to as the slope error budget. This supporting substrate structure, together with the light redirecting component, comprises at least a portion of a light reflecting device.

A heliostat is one type of light reflecting device. A heliostat is a term in the art that refers to device comprising one or more light reflecting surfaces that articulate to track the sun and reflect sunlight onto one or more desired targets. In many instances, the desired target is fixed relative to the earth. In many instances, a heliostat includes at least one light reflecting surface, a substrate structure that supports the surface, one or more drive mechanisms to articulate the light reflecting surface to track the sun, and a base structure to attach the heliostat to the ground, a frame, or other fixed or moveable mounting site.

The adverse impact of slope errors upon heliostat performance becomes more pronounced with increasing distance from the target. This is less of an issue with solar trough reflectors as often these are integrated into CSP systems in which the mirror-to-target distance is relatively low and where the mirror-to-target distance is similar for all mirror panels. On the other hand, heliostats used in CSP systems may have much longer distances between the light redirecting panels and a centralized, common target. In some systems, this distance can be up to a mile or more. Heliostat-based CSP systems of this magnitude are less tolerant to slope error and may experience significant losses in energy production if the slope errors are too large.

Minimizing slope errors is a key aspect of heliostat engineering. From design, through fabrication and assembly, and ultimately through the performance under operating conditions, there are a number of factors that influence the slope error characteristics of a light reflecting device. A key factor is the influence of temperature changes and differential thermal expansion characteristics between the light redirecting surface and its supporting structure.

Composite sandwich construction is well known. A composite sandwich panel assembly typically includes two stressed skins separated by and bonded to a core material. The attachment between the core and skins is usually accomplished using some type of adhesive and/or mechanical coupling. The resulting composite panel structure often uses materials efficiently for the stiffness and strength achieved.

Ongoing efforts to implement a composite sandwich panel as a support structure for light reflecting panels have been attempted. Exemplary composite sandwich structures are described in U.S. Pat. No. 8,132,391 B2 and U.S. Pat. No. 8,327,604 B2. These include top and bottom skins coupled by a core region. Instead of making the core from a separate piece of material, the core structure in these designs is formed as riser elements that are an integral part of one of the skins. This is achieved by perforating a metal sheet at regular intervals and folding up “riser elements” perpendicular to the parent material of the skin. The tips of the riser elements are folded over to create tabs that are bonded to the back side of the other sheet of skin material to form the composite structure.

In the past, this structure has been used in parabolic troughs but is now being considered for heliostat applications in which light is concentrated by a plurality of heliostats onto a common target. One particular configuration under development uses a backer sheet with integral riser elements that are bonded to the back side of another continuous sheet of the same material to form the sandwich panel. A reflective film is adhered to the front side of the continuous sheet to create a mirror surface.

One of the potential challenges associated with this approach is that it results in differential thermal expansion between the composite panel and the reflector mounted to it. This could result in undue slope error issues with a glass mirror if steps are not taken to accommodate the relative movement attributed to thermal expansion differences while still providing a structure with desired structural integrity.

### SUMMARY OF THE INVENTION

The present invention provides strategies for reducing the harmful effects of differential thermal expansion in light reflecting devices having improved structural properties as well. Significantly, the present invention helps to reduce the vulnerability of light reflecting surfaces to slope error issues that could be associated with differential thermal expansion among composite components. The principles of the present invention may be used to prepare a wide range of mirrors, heliostats, siderostats, coelostats, trough reflectors, dish reflectors, solar trackers, and other similar devices that are useful in systems such as telescopes, solar panels, solar power plants or systems, and the like. The principles of the present invention are particularly useful for making heliostats in the field of concentrating solar power.

In illustrative modes of practice, heliostat devices integrate light reflecting panels supported by a composite substrate structure that helps to provide the resultant assembly with structural integrity, stiffness, and reduced slope errors due to changes in temperature. Light reflecting panels are coupled to the supporting, composite substrate by a plurality of flexible connecting elements. Advantageously, the composite approach of the present invention effectively separates structural and thermal compensation functions. Specifically, the composite substrate structure helps to provide desired structural properties. In the meantime, the flexible connecting elements couple the top, reflective panel to the support structure in a manner that helps to isolate the light reflecting panel from thermal stresses that otherwise could cause undue slope errors.

As another key advantage, the present invention allows a greater range of materials to be used to fabricate the assembly. In the past, designers of light redirecting composite panels may have restricted their choices of skin materials to those with matching or similar coefficients of thermal expansion in order to help mitigate differential thermal expansion effects. However, by flexibly attaching the light redirecting panel to the composite substrate structure rather than making the light redirecting panel an inflexibly attached skin of the composite itself, the present invention greatly reduces slope errors that might otherwise result from thermal effects. Consequently, design choices are expanded so that more optimum materials can be selected for the composite skin, core, and reflecting materials, without placing as much restriction on the coefficients of thermal expansion. The present invention is particularly useful when the individual skins are made from materials with different coefficients of thermal expansion, as often is desired when optimizing performance.

Components made from a material such as aluminum has been difficult to integrate into heliostat designs in that the coefficient of thermal expansion of aluminum is relatively high. Due to this circumstance, the light-redirecting performance of mirror structures incorporating aluminum components can fall off dramatically with changes in temperature. In contrast, the relatively high coefficients of thermal expansion of aluminum and other materials have substantially less impact upon the performance of heliostat structures that incorporate principles of the present invention. Significantly, therefore, the present invention opens up opportunities to use aluminum (and/or other materials with relatively high coefficients of thermal expansion) components instead of steel, which could significantly reduce weight and improve long-term corrosion resistance. In many illustrative embodiments, the open structure of the composite panels also would help to limit the accumulation of dew and frost.

Because connecting elements of the present invention flexibly couple the light redirecting panel to a structurally stiff, composite substrate, the use of thinner glass as a light reflecting element may be feasible. This can help reduce the overall weight and can result in better mirror reflectivity. Note, however, that if the glass were too thin, the bending stiffness, durability and weatherability of the glass may be less than desired. For example, at some thickness threshold, a minimum stiffness required to resist gravity or wind loads may be an important design variable to select a suitable thickness of a glass panel.

A significant advantage of the present invention is that the stiffness of the substrate structure of the present invention may be tuned by adjusting the size, shape, layout density, layout pattern, orientation, and other characteristics of the connecting elements in those embodiments that use a plurality of connecting elements to couple skins used in the substrate structure. The connecting elements that independently couple the substrate structure to the top, reflective panel need not be tuned for stiffness in many embodiments, and even can be quite flexible so long as the connecting elements are able to suitably support the top panel through the range of heliostat motion.

In one aspect, the present invention relates to a light reflecting device that re-directs light at a target, said light reflecting device comprising:
(a) a supporting substrate structure comprising a first skin, a second skin, and a core region that physically couples the first skin to the second skin;
(b) a light reflecting panel comprising a light reflecting surface; and
(c) a plurality of flexible connecting elements that couple the light reflecting panel to the supporting substrate structure in a manner such that the light reflecting panel is spaced apart from the substrate structure.

In another aspect, the present invention relates to a concentrating solar power system, comprising:
(a) a central target; and
(b) a plurality of heliostats that redirect and concentrate sunlight onto the central target, wherein at least one of the heliostats comprises a light reflecting assembly comprising:
   (i) a support comprising a first skin, a second skin, and a core region that physically couples the first skin to the second skin;
   (ii) a light reflecting panel comprising a light reflecting surface; and
   (iii) a plurality of flexible connecting elements that couple the light reflecting panel to the support in a manner such that the light reflecting panel is spaced apart from the support.

In another aspect, the present invention relates to a method of making a light reflecting device, comprising the steps of:
(a) providing a supporting substrate structure comprising a first skin, a second skin, and a core region that physically couples the first skin to the second skin;
(b) providing a light reflecting panel comprising a light reflecting surface; and
(c) providing a plurality of flexible connecting elements that couple the light reflecting panel to the supporting substrate structure in a manner such that the light reflecting panel is spaced apart from the supporting substrate structure

In another aspect, the present invention relates to a light reflecting device comprising:
(a) a bottom skin comprising first and second opposed major faces;
(b) an intermediate skin having first and second opposed major faces and that is spaced apart from the bottom skin, wherein the first major face of the intermediate skin faces toward the bottom skin and the second major face of the intermediate element faces away from the bottom skin, and wherein the intermediate skin optionally comprises a plurality of openings providing egress through the intermediate skin;
(c) a top panel having first and second opposed, major faces, wherein the top panel is spaced apart from the bottom skin and the intermediate skin, wherein the first major face of the top panel faces toward the bottom skin and the intermediate skin and the second major face of the top panel comprises a reflective surface facing away from the bottom skin and the intermediate skin;
(d) a first core region coupling the intermediate skin to the bottom skin; and
(e) a plurality of flexible connecting elements independently coupling the top panel to at least one of the bottom and intermediate skins, wherein in some preferred embodiments the flexible connecting elements pass through the openings of the intermediate skin to couple the bottom skin to the top panel.

In another aspect, the present invention relates to a heliostat comprising an articulating light reflecting assembly, wherein the light reflecting assembly comprises:
(a) a bottom skin comprising first and second opposed major faces;
(b) an intermediate skin having first and second opposed major faces and that is spaced apart from the bottom skin, wherein the first major face of the intermediate skin faces toward the bottom skin and the second major face of the intermediate skin faces away from the bottom skin, and wherein the intermediate skin optionally comprises a plurality of openings providing egress through the intermediate skin;
(c) a top panel having first and second opposed, major faces, wherein the top panel is spaced apart from the bottom skin and the intermediate skin, and wherein the first major face of the top panel faces toward the bottom skin and the intermediate skin and the second major face of the top panel comprises a reflective surface facing away from the bottom skin and the intermediate skin; and
(d) a core region that couples the intermediate skin to the bottom skin; and
(e) a plurality of flexible connecting elements coupling at least one of the bottom skin and the intermediate skin to the top panel.

In another aspect, the present invention relates to a concentrating solar power system, comprising:
(a) a central target; and
(b) a plurality of heliostats that reflect and concentrate sunlight onto the central target, wherein at least one of the heliostats comprises a light reflecting assembly comprising:
   (i) a bottom skin comprising first and second opposed major faces;
   (ii) an intermediate skin having first and second opposed major faces and that is spaced apart from the bottom skin, wherein the first major face of the intermediate skin faces toward the bottom skin and the second major face of the intermediate skin faces away from the bottom skin, and wherein the intermediate skin optionally comprises a plurality of openings providing egress through the intermediate skin;
   (iii) a top panel having first and second opposed, major faces, wherein the top panel is spaced apart from the bottom skin and the intermediate skin, and wherein the first major face of the top panel faces toward the bottom skin and the intermediate skin and the second major face of the top panel comprises a reflective surface facing away from the bottom skin and the intermediate skin; and
   (iv) a core region coupling the intermediate skin to the bottom skin; and
   (v) a plurality of flexible connecting elements coupling the top panel to at least one of the bottom skin and the intermediate skin, wherein in some preferred embodiments the flexible connecting elements pass through the openings of the intermediate skin to couple the bottom skin to the top panel.

In another aspect, the present invention relates to a method of making a heliostat, comprising the steps of:
(a) providing a light reflecting assembly, comprising the steps of:
   (i) providing a bottom skin having a bottom surface and a top surface;
   (ii) providing an intermediate skin having a bottom surface and a top surface and a plurality of openings therein to provide egress through the intermediate skin; and
   (iii) providing a top panel having a bottom surface and a reflective top surface;
   (iv) providing a core region that couples the bottom skin to the intermediate skin in a spaced apart fashion;
   (v) providing a plurality of flexible connecting elements that couple the bottom skin to the top panel, wherein the connecting elements pass through the openings in the intermediate skin; and
(b) mounting the light reflecting assembly onto a support structure in a manner such that the light reflecting element articulates to track the sun and reflecting sunlight onto a target.

### BRIEF DESCRIPTION OF THE DRAWINGS

FIG. 1 is a schematic illustration of a concentrated solar power system incorporating principles of the present invention.

FIG. 2 schematically illustrates a heliostat used in the power system of FIG. 1, wherein the heliostat incorporates a composite light reflecting panel of the present invention.

FIG. 3 schematically illustrates an isometric section view of a portion of the composite light reflecting panel assembly of FIG. 2.

FIG. 4 is a side view of the composite light reflecting panel assembly of FIG. 2.

FIG. 5 is a top view of the bottom skin used in the composite light reflecting panel assembly of FIG. 2.

FIG. 6 is an isometric side view of a portion of the composite light reflecting panel assembly of FIG. 2.

FIG. 7 is an exploded isometric view of the composite light reflecting panel assembly of FIG. 2.

FIG. 8 schematically illustrates a step by step method for making the composite light reflecting panel assembly of FIG. 2.

FIG. 9 is an exploded isometric view of an alternative embodiment of a composite light reflecting panel assembly of the present invention.

FIG. 10 is an isometric section view of a portion of the composite light reflecting panel assembly of FIG. 9.

FIG. 11 is an isometric bottom perspective view of a portion of the intermediate skin and its integral connecting elements used in the composite light reflecting panel assembly of FIG. 9.

FIG. 12 is an exploded isometric view of an alternative embodiment of a composite light reflecting panel assembly of the present invention.

FIG. 13 is a bottom isometric perspective view of a portion of the composite light reflecting panel assembly of FIG. 12.

FIG. 14 is an alternative isometric perspective section view of a portion of the composite light reflecting panel assembly of FIG. 12.

FIG. 15 is an isometric perspective view of the intermediate skin used in the assembly of FIG. 2 wherein the intermediate skin includes optional strengthening ribs.

FIG. 16 is an isometric perspective view of the bottom skin used in the assembly of FIG. 2 wherein the bottom skin includes optional strengthening ribs.

FIG. 17 is an isometric perspective view showing the intermediate skin of FIG. 15 attached to the bottom skin of FIG. 16.

FIG. 18 is a top view of an alternative embodiment of a bottom skin in which connecting elements are deployed on four, nested involute curves.

FIG. 19 is an isometric perspective view of the bottom skin of FIG. 18 shown in combination with a corresponding intermediate skin connecting element.

FIG. 20 is a perspective view of a portion of an alternative embodiment of a composite light reflecting panel assembly of the present invention.

FIG. 21 is another perspective view of a portion of the composite light reflecting panel assembly of FIG. 20.

FIG. 22 is an exploded isometric view of the composite light reflecting panel assembly of FIG. 20.

### DETAILED DESCRIPTION OF PRESENTLY PREFERRED EMBODIMENTS

The present invention will now be further described with reference to the following illustrative embodiments. The embodiments described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

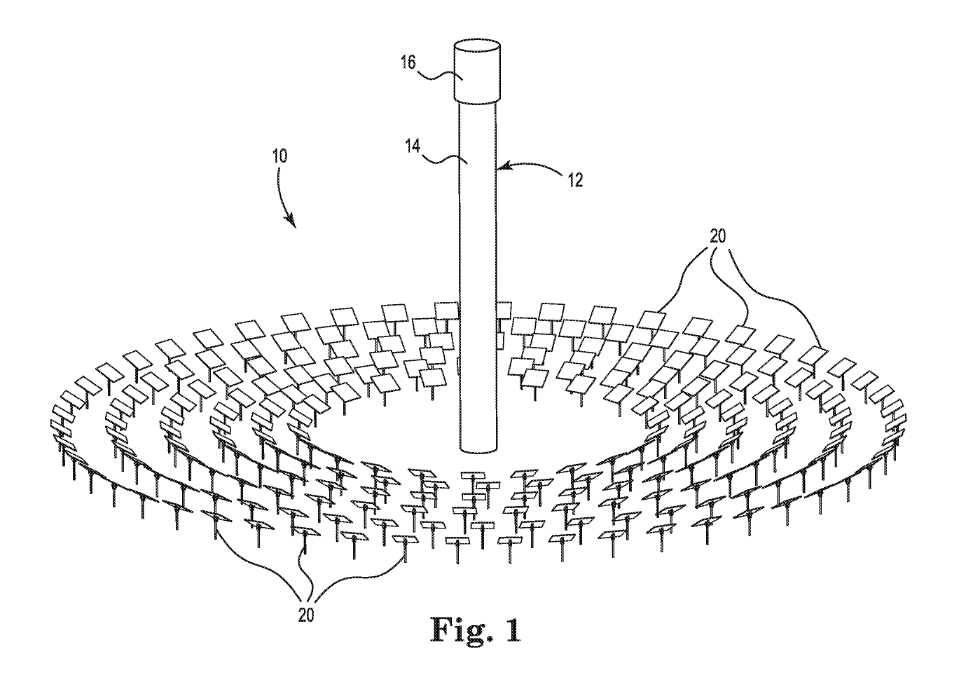

Referring to the figures, FIG. 1 schematically illustrates a concentrating solar energy system 10 that incorporates principles of the present invention. System 10 includes a central tower 12 including a mast 14 and a target region 16 at the top of the mast. A field of heliostats 20 is deployed around central tower 12. The heliostats 20 redirect and concentrate incident sunlight onto target region 16. If system 10 embodies a photovoltaic solar power system (a.k.a. concentrating photovoltaics, or CPV), target region 16 generally would include solar cells (not shown) that absorb the concentrated light and generate electricity that could then be stored for later use or distributed to one or more users or a power grid or the like. If system 10 embodies a concentrating solar power (CSP) system, used to convert thermal energy into electricity or mechanical energy (not shown), then the thermal energy generated on target region 16 may be used to heat a working fluid. The thermal energy in the heated fluid may then be used directly or indirectly to generate electricity or pressure. A CSP embodiment of system 10 is particularly useful in molten salt-based power systems such as those described in U.S. Pat. Nos. 8,833,076; 8,697,271; 7,726,127; 7,299,633; and U.S. Pat. Pub. No. 213/0081394 A1.

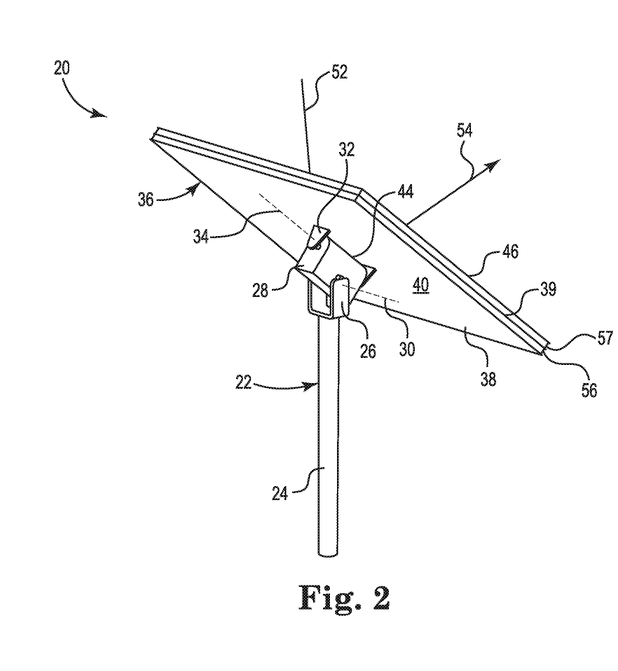

FIG. 2 schematically illustrates an exemplary embodiment of heliostat 20 used in system 10 of FIG. 1. Heliostat 20 includes a support structure 22 including a post 24 and a first, fixed yoke 26. Yoke 26 is pivotably coupled to a drive mechanism 28. Yoke 32 is fixedly coupled to a centrally located attachment site 44 of a light redirecting panel assembly in the form of composite mirror panel assembly 36.

Drive mechanism 28 can be controllably actuated to pivot drive mechanism 28 around fixed, horizontal axis 30. Drive mechanism 28 also is pivotably coupled to second yoke 32. Drive mechanism can be actuated to controllably pivot yoke 32 about second axis 34. In practical effect, because drive mechanism 28 can control movement around both axes 30 and 34, composite mirror panel assembly 36 can be articulated to track the sun so that incident light ray 52 is reflected as reflected light ray 54 to be aimed at target region 16 (FIG. 1). Composite mirror panel assembly 36 includes bottom skin 38, an intermediate skin 39, top light redirecting panel 46 (also referred to as top skin 46), and core regions 56 and 57.

As described further below, core regions 56 and 57 comprise a plurality of connecting elements 60 and 70 to independently couple each of skins 39 and 46 to bottom skin 38. Connecting elements 60 in core region 56 couple skins 38 and 39 to form a composite structural support panel to which skin 46 is flexibly coupled via core elements 70 extending through core regions 56 and 57 from bottom skin 38 to top skin 46.

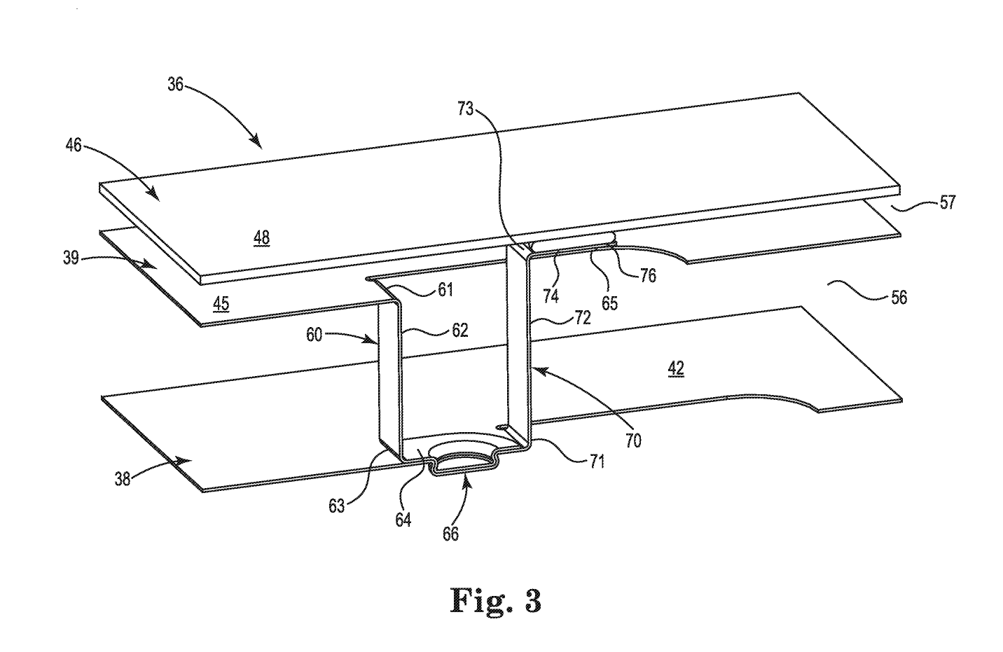

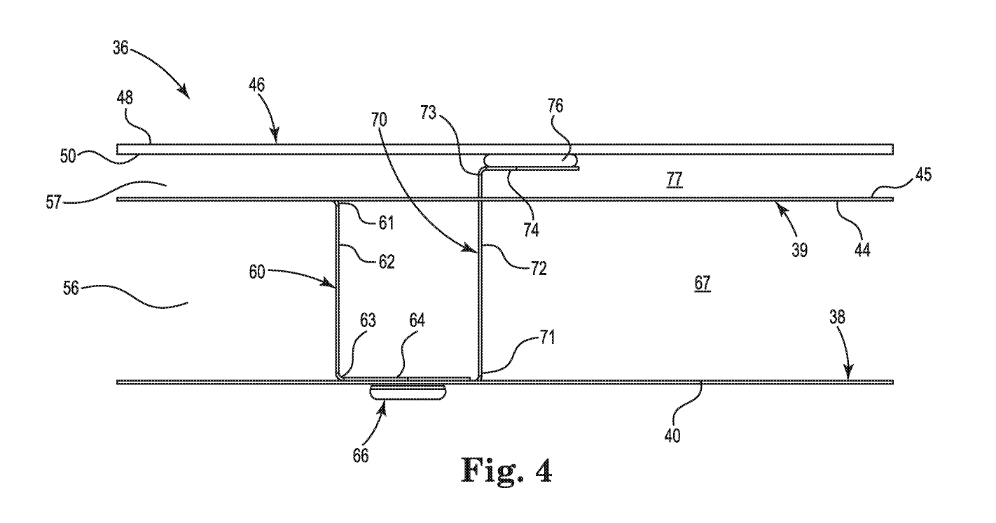

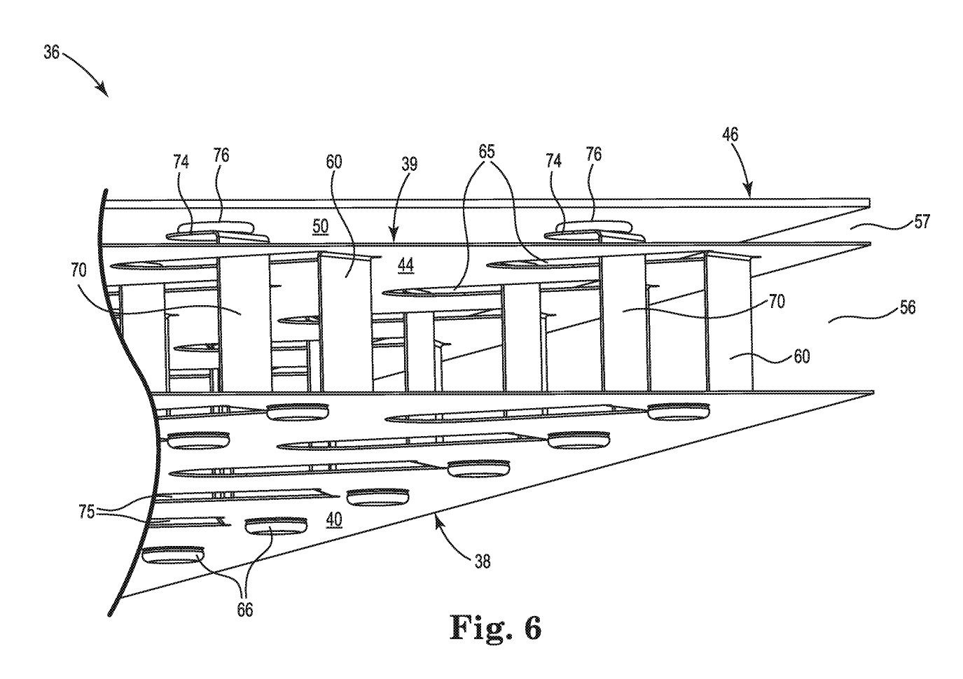

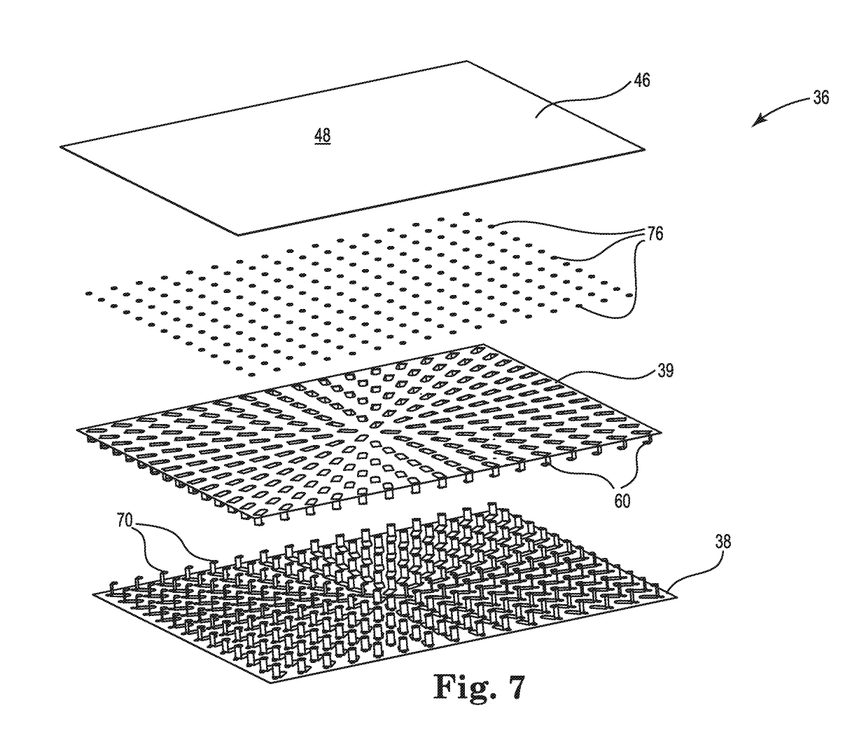

FIGS. 3 to 8 show composite mirror panel assembly 36 of FIG. 2 in more detail. Bottom skin 38 has bottom surface 40 and top surface 42. Intermediate skin 39 has a bottom surface 44 and a top surface 45. Top skin 46 has reflective top surface 48 and bottom surface 50. Top surface 48 is shown as being generally flat, but other geometries also may be used. For example, top surface 48 may be convex, concave, curved in two or three dimensions, faceted, or the like.

Bottom skin 38 and intermediate skin 39 are separated in a spaced apart fashion by core region 56. Core region 56 may be formed integrally with skins 38 and/or 39 or may be formed from one or more separate core constituents. As shown, core elements 60 are integral with intermediate skin 39 and are coupled to bottom skin 38. Top skin 46 is suspended away from and spaced apart from intermediate skin 39 by core region 57. As is the case with core region 56, core region 57 may be formed integrally with skins 38, 39, and/or 46, or may be formed from one or more separate core constituents. As shown, core elements 70 are integral with bottom skin 38 and pass through corresponding openings in intermediate skin 39 to attach skin 46 to bottom skin 38.

Thus, each of intermediate and top skins 39 and 46 is independently coupled to bottom skin 38 by connecting elements 60 and 70, respectively. Although each of skins 39 and 46 are independently coupled to bottom skin 38, skins 39 and 46 are de-coupled from each other in this embodiment. This approach provides substantial advantages. In particular, bottom skin 38 and intermediate skin 39 can be fabricated in a manner effective to provide assembly 36 with substantial structural integrity, structural stability, and stiffness. In the meantime, because skins 38 and 39 contribute to a substantial portion of the structural properties, top skin 46 can be fabricated to optimize reflective characteristics without having the extra burden of having to also provide a substantial portion of the structural properties as well. Further, each of the skins 39 and 46, being physically de-coupled from each other, are able to respond to thermal stresses independently. Assembly 36, therefore, provides reflective characteristics that are less prone to slope errors than conventional composite approaches such as those described in U.S. Pat. Nos. 8,132,391 B2 and U.S. Pat. No. 8,327,604 B2.

In many embodiments, each of skins 38, 39, and 46 independently may be formed from a single sheet of material or may be a laminate structure formed from two or more sheets. Each of skins 38, 39, and 46 independently may be formed from a wide range of materials. In illustrative embodiments, bottom skin 38 and intermediate skin 39 may be formed from strong, stiff, resilient materials with high tensile strength, such as one or more metals, metal alloys, intermetallic compositions, polymers, reinforced composites, combinations of these, and the like. Preferred materials for forming skins 38 and 39 include carbon steel, stainless steel, aluminum, one or more polymers, composites (such as polymer matrices reinforced with carbon fibers, fiberglass, metallic fibers, cellulosic material, combinations of these, or the like), combinations of these, or the like.

Each of skins 38 and 39 independently may be provided with a thickness selected from a wide range of suitable thicknesses. In many embodiments, skins 38 and 39 have a thickness of 0.005 inches to 0.5 inches, or even 0.05 inches to 0.375 inches, or even 0.1 to 0.25 inches.

In illustrative embodiments suitable for heliostat applications, top skin 46 may be formed from a reflective sheet or a reflective sheet supported upon a suitable support. Examples of reflective sheets include polished aluminum, float glass mirrors, reflective polymer films, retroreflective films, combinations of these, and the like. If a reflective sheet is supported on an underlying substrate, suitable materials for the substrate can be selected from the same materials used to form the bottom and/or intermediate skins 38 and 39.

In a specific embodiment, the bottom skin 38 and intermediate skin 39 are formed from an aluminum sheet having a thickness of 0.03 inches having a coefficient of thermal expansion of 0.000022 m/(mK), while the top skin 46 is formed from a glass mirror having a thickness of 0.120 inches and a coefficient of thermal expansion of about 0.000009 m/(mK).

As shown in FIGS. 3 to 8, a plurality of connecting elements 60 couple bottom skin 38 to intermediate skin 39 in a spaced apart fashion to help define and provide core region 56. Thus, gap 67 separates bottom skin 38 from intermediate skin 39. Each connecting element 60 is integrally formed from a corresponding portion of intermediate skin 39. Each connecting element 60 may be formed by separating the perimeter of the connecting element 60 from intermediate skin 39 by any suitable technique such as shearing, punching, cutting, etching, thermoforming, combinations of these, and the like. Each connecting element 60 is folded downward from intermediate skin 39 toward bottom skin 38 at bending line 61. Corresponding openings 65 are formed in intermediate skin 39. Advantageously, these openings 65 provide portals through which top skin 46 can be coupled to bottom skin 38 by connecting elements 70 that pass through these openings 65. Tab 64 is formed at the end of each connecting element 60 by folding over body 62 at bending line 63. Tab 64 provides an attachment surface to couple each connecting element 60 to bottom skin 38. The attachment can occur by any suitable technique, including gluing, welding, brazing, riveting, clinching, combinations of these, and the like. For purposes of illustration, tabs 64 are clinched to bottom skin 38 at junctures 66.

Advantageously, connecting elements 60 couple skins 38 and 39 to form a strong, stiff, resilient composite structure, while connecting elements 70 couple skins 38 and 46 and help to mitigate thermal stresses that could develop among skins 38, 39, and 46.

A plurality of connecting elements 70 couple bottom skin 38 to top skin 46 in a spaced apart fashion relative to bottom skin 38 and intermediate skin 39 so that top skin 46 is suspended away from and physically de-coupled from intermediate skin 39 in a manner to help define core region 57. Thus, gap 77 separates top skin 46 from intermediate skin 39. Each connecting element 70 is integrally formed from a corresponding portion of bottom skin 38. Each connecting element 70 may be formed by separating the perimeter of the connecting element 70 from bottom skin 39 by any suitable technique such as shearing, punching, cutting, etching, thermoforming, combinations of these, and the like. Each connecting element 70 is folded upward from bottom skin 38 toward top skin 46 at bending line 71. Corresponding openings 75 are formed in bottom skin 38.

Advantageously, connecting element 70 passes through openings 65 in intermediate skin 39 when coupling skin 38 to skin 46 desirably without connecting elements touching skin 39 even when slightly flexed to accommodate thermal stresses. Tab 74 is formed at the end of each connecting element 70 by folding over body 72 at bending line 73. Tab 74 provides an attachment surface to couple each connecting element 70 to top skin 46. The attachment can occur by any suitable technique, including gluing, welding, brazing, riveting, clinching, combinations of these, and the like. For purposes of illustration, tabs 74 are glued to top skin 46 by adhesive beads 76. Advantageously, connecting elements 70 couple skins 38 and 46 in a manner effective to help to mitigate thermal stresses that could develop among skins 38, 39, and 46.

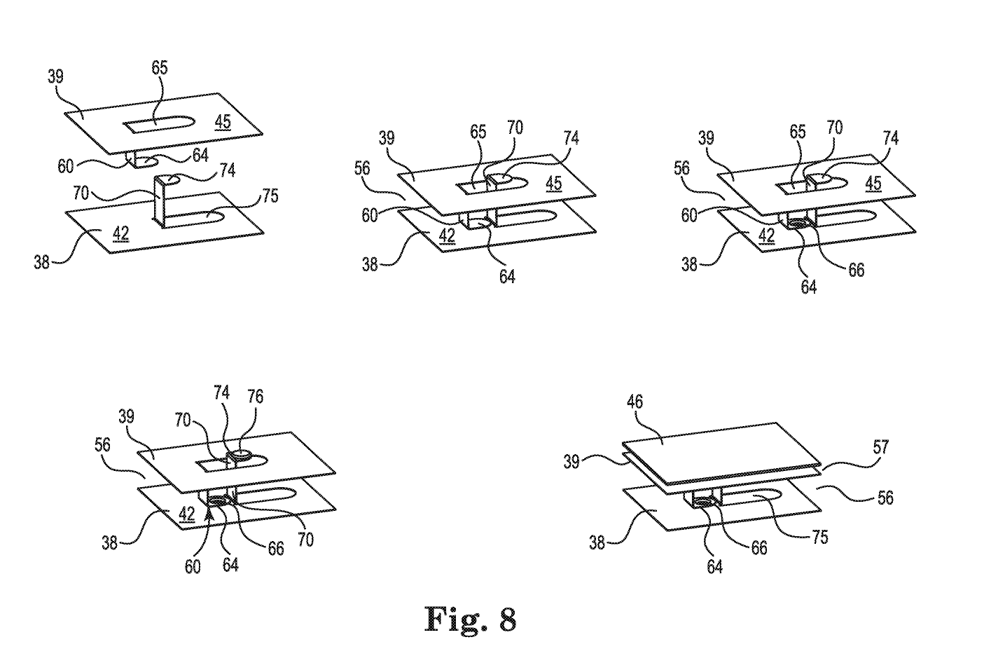

FIG. 8 schematically illustrates one approach for fabricating assembly 36. For purposes of illustration, only portions of skins 38, 39, and 46 are shown to illustrate how a corresponding pair of connecting elements 60 and 70 are used to couple the skins together. In a first step, connecting elements 60 and 70 are formed in skins 39 and 38, respectively. Intermediate skin 39 is placed in position over bottom skin 38 so that connecting elements 60 project from skin 39 toward surface 42 and so that connecting elements 70 are aligned with corresponding openings 65.

In step 2, intermediate skin 39 is lowered so that skin 39 is supported in spaced apart fashion above skin 38 by connecting elements 60. Tab 64 is in contact with skin 38. Connecting element 70 projects upward from skin 38 and through the opening 65 in intermediate skin 39. Consequently, tab 74 provides a support surface above and spaced apart from intermediate skin 39. Skins 38, 39 are nested so tabs 70 protrude through holes 65 in skin 39.

In step 3, tab 64 is coupled to bottom skin 38 in any suitable fashion. For purposes of illustration, tab 64 is clinched to skin 38 at attachment site 66. Tab 60 is fastened to skin 38.

In step 4, adhesive bead 76 is provided on the tab 74. In step 5, the top skin 46 is installed, being supported on tab 74 and glued in place.

The top skin 46 generally will tend to absorb some degree of thermal energy from the incident sunlight. In an embodiment, the top skin 46 may be a mirror. Due to factors including the manner in which the connecting elements 60 and 70 are integrally formed from the intermediate skin 39 and bottom skin 38, respectively, and the manner in which the connecting elements help to couple the skins 38, 39, and 46 to each other in a spaced apart fashion, the combination of the bottom skin 38, intermediate skin 39, and connecting elements 60 and 70 is believed to also function as an effective heat sink. The heat exchanger characteristics help to add or remove heat from the top skin 46. For example, when oriented at an angle relative to horizontal the composite panel assembly might experience natural convective heat transfer, depending on the temperature of the skins 38, 39, and 46. This can help dissipate heat from the skins 38, 39, and 46. The convective flow helps to equilibrate skins 38, 39, and 46 to ambient temperature.

This also could help heat the top skin 46 during colder weather. The heat transfer characteristics may be a significant benefit when colder temperatures otherwise could cause frost formation on the reflective surface 48 of top skin 46. In some embodiments, the bottom skin 38 may be painted a darker color and the heliostat 20 can be actuated to present that darker surface to the incident sunlight during cold mornings to enhance frost removal. Additionally, a thermally conductive adhesive may be used to bond the connecting elements 70 to the top skin 46, enhancing heat exchange further.

In some embodiments, the use of an aluminum sheet to form bottom skin 38 can enhance the heat exchange properties even further due to the relatively high thermal conductivity of aluminum. In some embodiments, the use of a relatively thin glass sheet (e.g., a glass sheet having at thickness of 2 mm or less) to form the top skin 46 may be advantageous to help facilitate heat exchange to and from the non-insulated bottom surface 50 of the top skin. In such embodiments, the bottom surface 50 of such a glass sheet optionally may be reinforced with fibers to improve strength and durability of the sheet. Such fiber reinforcement not only would help with thermal stresses, but also stresses due to gravity, articulation, wind, hail strikes, and other loads. Techniques for providing such fiber reinforcement on glass sheets are described in U.S. Pat. Nos. 8,132,391 B2 and 8,327,604 B2.

Another technique to reinforce thin glass sheets used as top skin 46 comprises coating the bottom surface 50 with a fiber reinforced coating such as a fiber reinforced resin matrix, fiber reinforced paint, combinations of these, and the like. Exemplary fibers may be in the form of woven or non-woven mat or cloth, loose fibers mixed with the coating composition used to form the coating, oriented fibers, combinations of these, or the like. Exemplary fibers may be natural and/or synthetic and include fiberglass, carbon fiber, cellulosic fiber, ceramic fiber, polymeric fiber (such as the well-known Kevlar brand aramid fiber), metal alloy fibers, combinations of these, and the like. Using a fiber reinforced coating allows the top skin 46 to have improved toughness using easily applied, reliable coating techniques without the need to bond another laminate layer to form skin 46.

Composite mirror panel assemblies 36 of the present invention may incorporate one or more additional features to help enhance heliostat characteristics and performance. An exemplary optional component is a perimeter skirt. As described in the SolarPACES 2013 paper Wind Load Reduction for Light-Weight Heliostat, by A. Pfahl, A. Brucks and C. Holze, wind tunnel testing has demonstrated that raised perimeter features on a mirror can reduce the hinge moment in a stowed position by up to 40%. Such perimeter features also may improve aerodynamic characteristics (e.g., reduced wind cross-section). Strategies for incorporating perimeter skirt features on heliostats is further described in Assignee's Co-pending U.S. patent application titled COMPOSITE SANDWICH MIRROR PANEL USEFUL IN CONCENTRATED SOLAR POWER SYSTEMS, having Attorney Docket Number SLR0008/P1, filed Apr. 28, 2015 (concurrently herewith) in the name of Gregory et al.

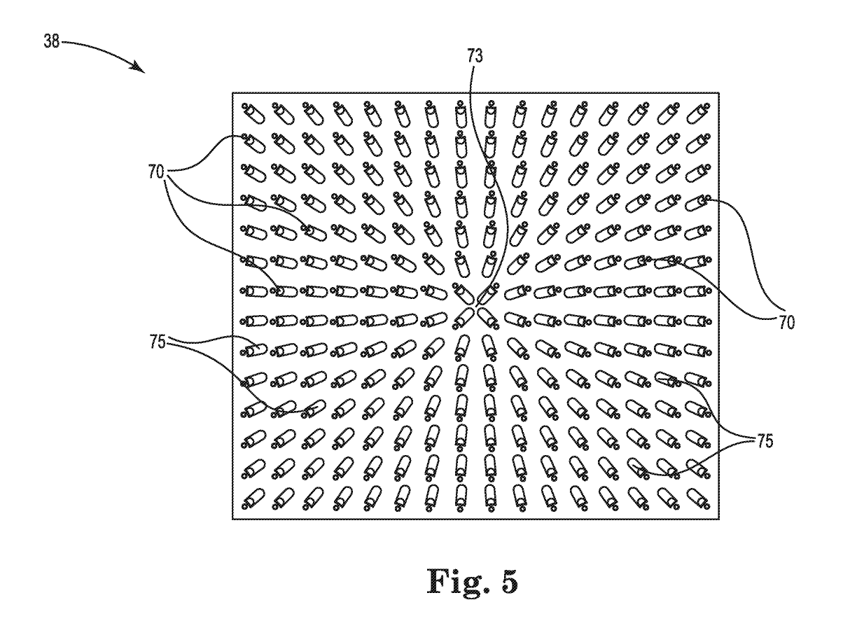

As seen best in FIG. 5, connecting elements 70 are deployed in a rectangular grid with each individual element 70 being in a radial alignment relative to a central region 73 of skin 38 to accommodate thermal expansion when assembly 36 is attached to another heliostat component proximal to central region 73. For example, the central region 73 of skin 38 may be coupled to a drive mechanism that articulates assembly 36 to carry out heliostat operations. A radial alignment of a connecting element occurs when the opposed major faces of a connecting element are oriented at 90 degrees+/−10 degrees relative to a reference line between that element and the central region 73.

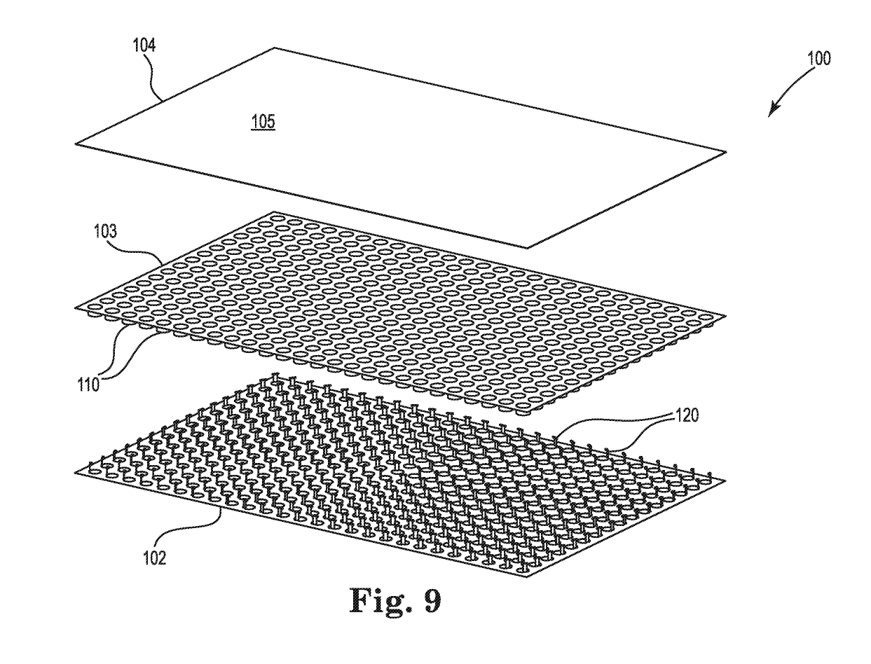

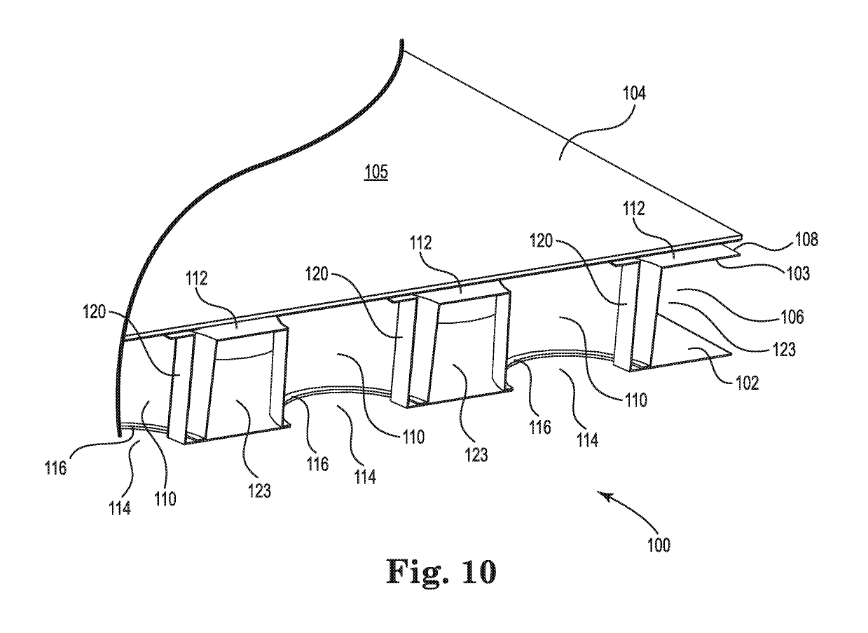

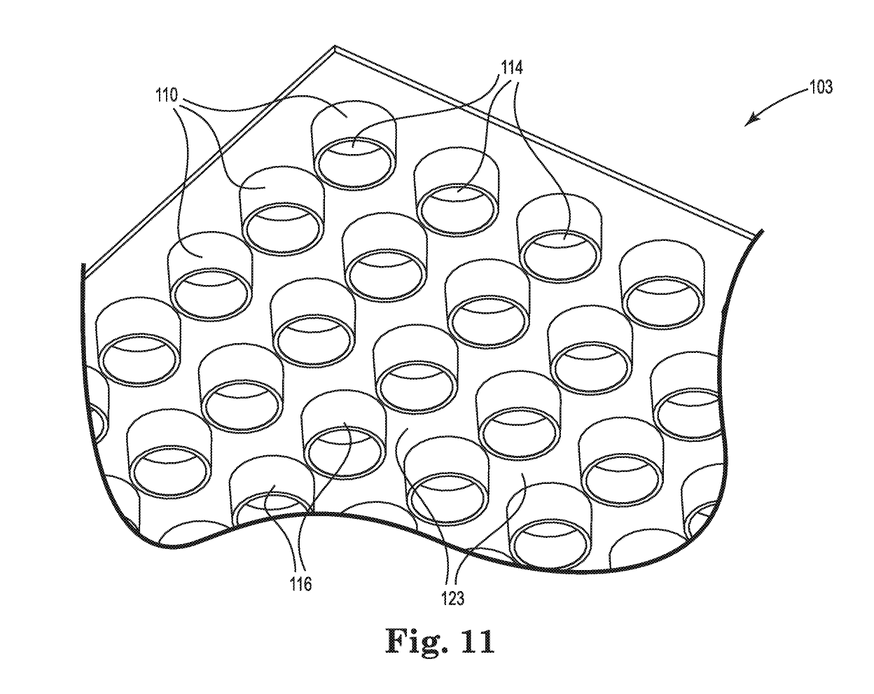

An alternative embodiment of a composite mirror panel assembly 100 of the present invention is shown in FIGS. 9 to 11. Assembly 100 is similar to assembly 36 of FIGS. 2 through 8 except that assembly 100 uses generally cylindrical connecting elements 110 in place of connecting elements 60 in order to rigidly couple intermediate skin 103 to bottom skin 102. In actual practice, the connecting elements 110 may slightly conical in shape, tapering from their bases skin 103 toward their ends at rims 116.

In more detail, assembly 100 includes bottom skin 102, intermediate skin 103, and top skin 104. Top skin has a top reflective surface 105. A plurality of cylindrically-shaped connecting elements 110 rigidly couple bottom skin 102 to intermediate skin 103 in a spaced apart fashion to help define core region 106. Each connecting element 110 is integrally formed with intermediate skin 103. Corresponding pathways 114 are provided through connecting elements 110 and intermediate skin 103. Advantageously, these pathways 114 provide portals through which top skin 104 can be coupled to bottom skin 102 by connecting elements 120 that pass through connecting elements 110. For purposes of illustration, the pathways 114 are shown as being generally round in cross-section, but these can be any shape. Desirably, a shape is used that is large enough to allow the connecting elements 120 to pass through for attachment of top skin 104. Bottom rim 116 of each connecting element 110 provides an attachment surface to couple each connecting element 110 to bottom skin 102. The attachment can occur by any suitable technique, including gluing, welding, brazing, riveting, clinching, combinations of these, and the like. For purposes of illustration, rims 116 are glued to bottom skin 102. Advantageously, connecting elements 110 couple skins 102 and 103 to form a strong, stiff, and resilient composite structure.

A plurality of connecting elements 120 couple bottom skin 102 to top skin 104 in a spaced apart fashion above bottom skin 102 and intermediate skin 103 so that top skin 104 is suspended above and physically de-coupled from intermediate skin 103 in a manner to help define core region 108. Thus, gap 112 separates top skin 104 from intermediate skin 103. Connecting elements 120 are similar in form and function to connecting elements 70 of FIGS. 3 to 8, except that connecting elements 120 pass through cylindrical connecting elements 110 in order to couple skins 102 and 104. According to an illustrative mode of practice as shown, connecting elements 120 may be deployed in a generally rectangular grid with each element 20 generally being oriented in a radial alignment relative to a central region of skin 102 to help accommodate thermal expansion when assembly 100 is attached to another heliostat component proximal to central region 73.

As an option, foam (not shown) may be included as a constituent of the core region 106 between skins 102 and 103 to help increase the structural stiffness. The foam also may allow thinner skins 102 and 103 to be used. Because foam is so much less dense than typical skin materials, this could provide lower weight and cost. If foam is used, the foam may be deployed in all or one or more portions of region 123 that is the volume of core region 106 outside the cylindrically shaped connecting elements 110. This way, the connecting elements 120 can pass through the pathways 114 inside the cylindrical connecting elements 110 without the foam outside the elements 110 interfering with the flexing of the elements 120. Foam reinforcement may be used in any embodiment of the invention, but the embodiment of FIGS. 9-11 is particularly suitable because the region 123 is isolated from the pathways 114.

If used, the foam may be provided in any suitable fashion. As one option, the foam may be pre-fabricated as a premade foam panel that is bonded or otherwise integrated into core region 106. As another option, foam may be sprayed into volume 123. Excess foam can be trimmed.

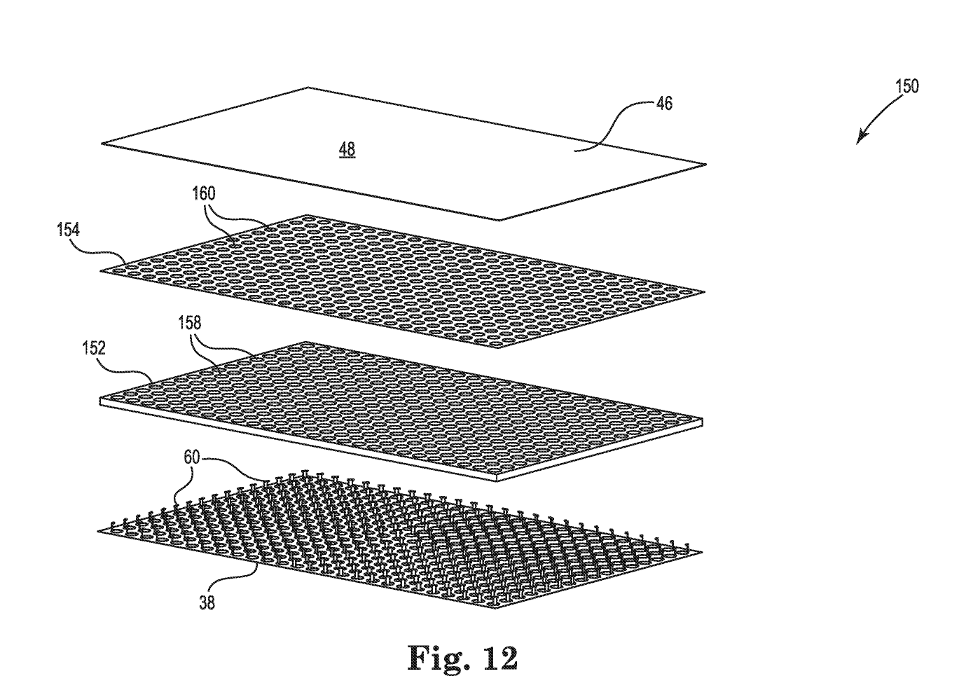

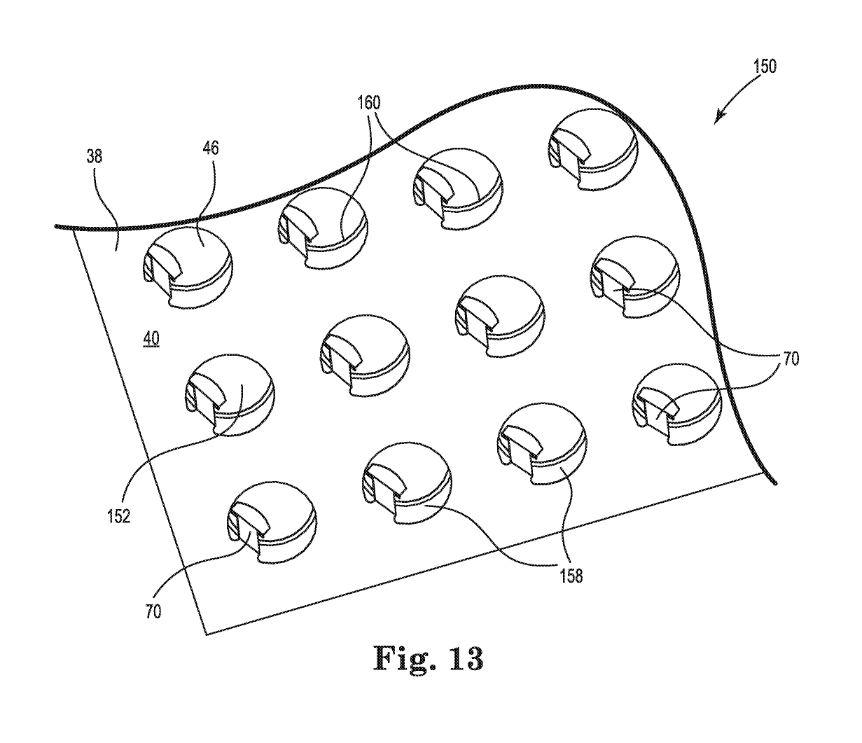

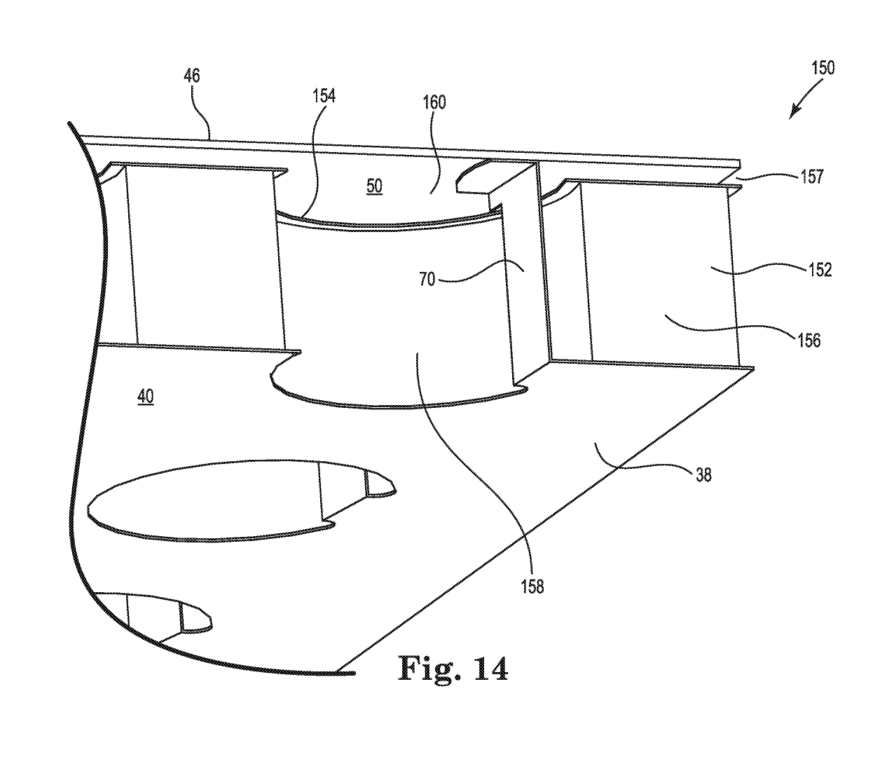

Another embodiment of a composite mirror panel assembly 150 is shown in FIGS. 12 to 14. FIGS. 12 to 14 show how skins 38 and 46 of FIGS. 2 to 8 can be incorporated into an alternative embodiment of a composite mirror panel assembly 150 in which an intermediate element including core 152 and intermediate skin 154 is substituted for intermediate skin 39. Core 152 provides a core region 156 that supports intermediate skin 154 in a spaced apart fashion from bottom skin 38.

Core 152 includes an array of through apertures 158 extending through core 152. Intermediate skin 154 includes an array of holes 160. When assembled, core 152 is bonded or otherwise coupled to bottom skin 38, and intermediate skin 154 is bonded to the top of core 152 so that holes 160 align with apertures 158. Connecting elements 70 project upward from bottom skin 38 through the apertures 158 and holes 160. The apertures 158 and holes 160 are shown as having generally circular cross-sections, but these can be any shape that allows passage of connecting elements 70. Top skin 46 is bonded to connecting elements 70 in a manner such that skin 46 is suspended in spaced part fashion from intermediate skin 154 to define core region 157.

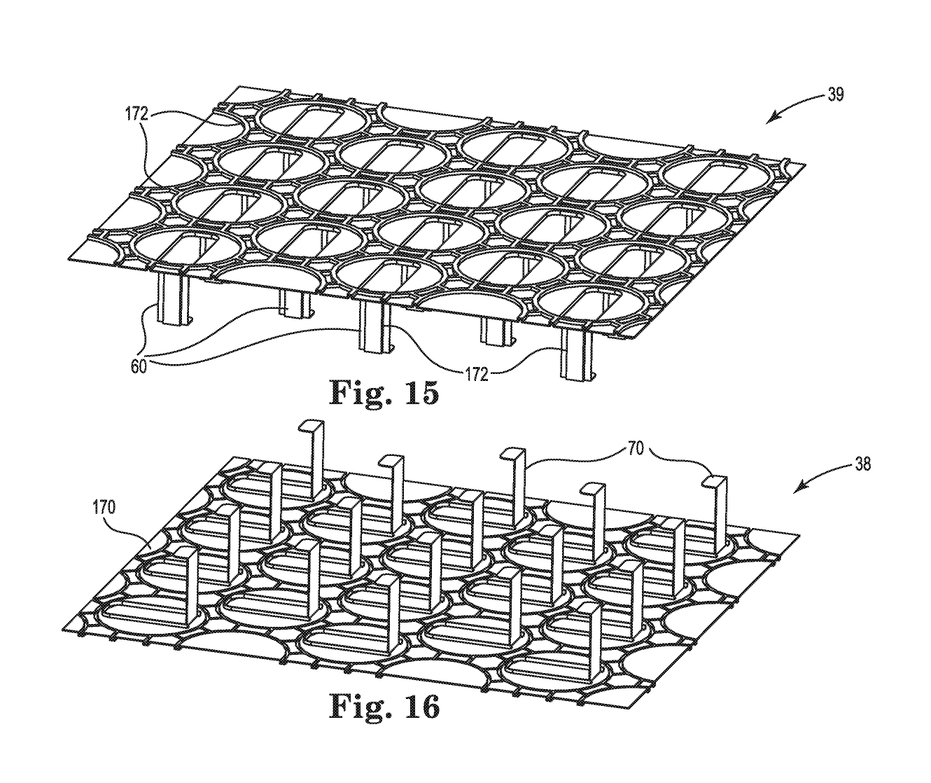

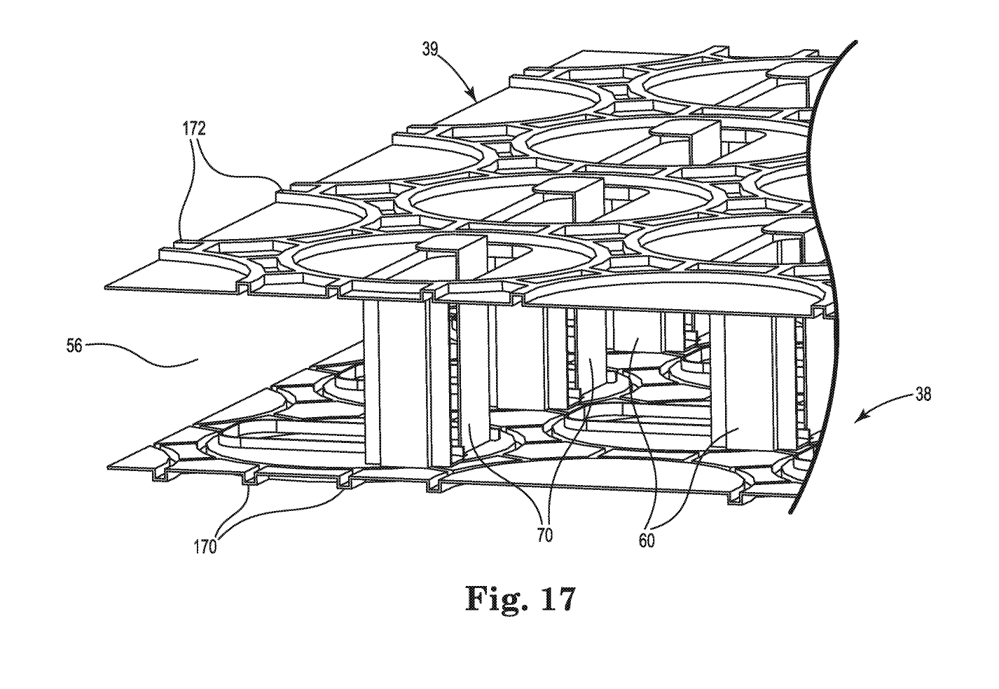

FIGS. 15 to 17 show optional features that may be incorporated into skins 38 and 39 of FIGS. 3 to 8. Specifically, each of skins 38 and 39 independently may be provided with strengthening ribs 170 and 172 to help stiffen each skin 38 and 39 as well as the resultant composite assembly 36. As an option, the connecting elements 60 and connecting elements 70 also may be arranged largely orthogonal to one another in an attempt to maintain more uniform omnidirectional stiffness in the core region 56.

The composite mirror panel assemblies 36, 100, 150, shown in FIGS. 3-17 are shown in which the connecting elements are similarly sized, similarly spaced, and similarly shaped. Other deployment strategies may be used to provide the connecting elements. For example the spacing, shapes, and orientation may be varied in order to tune shear stiffness characteristics of resultant composite panels at different locations of the panels. Techniques for tuning composite panels in this way are described in Assignee's Co-pending U.S. patent application titled COMPOSITE SANDWICH MIRROR PANEL USEFUL IN CONCENTRATED SOLAR POWER SYSTEMS, having Attorney Docket Number SLR0008/P1, filed Apr. 28, 2015 (filed concurrently herewith), in the names of Gregory et al. As other options, connecting elements used to support the skins in spaced apart fashion may be deployed not just in rectangular grids but in other geometric patterns as well. For example, connecting elements may be deployed in spirals, involute curves, concentric rings, or the like.

In preferred embodiments, the core stiffness between the bottom skin and intermediate skin (e.g., the stiffness provided by core region 56 in FIGS. 3 to 8) is relatively stiff in order to help provide a composite mirror panel assembly with high stiffness. In the meantime, the top panel is more flexibly integrated into the structure (e.g., the stiffness provided by core region 57 in FIGS. 3 to 8) may be relatively less stiff, and even relatively flexible, particularly in a radial direction relative to central region 73 (FIG. 5). The flexible coupling helps to minimize stresses induced by differential expansion of two dissimilar materials. The preferred embodiments having this structure help to reduce negative effects of thermal stresses by effectively separating the structural and thermal functions among different constituents of the assembly.

Connecting elements in embodiments described above are deployed on rectangular grids, optionally with a radial alignment of individual coupling elements relative to a reference site. Other deployment strategies also are suitable. For example, one example of an alternative strategy deploys connecting elements on one or more involute curves. Using involute curve(s) makes it easier to independently tune properties of individual or small groups of the connecting elements

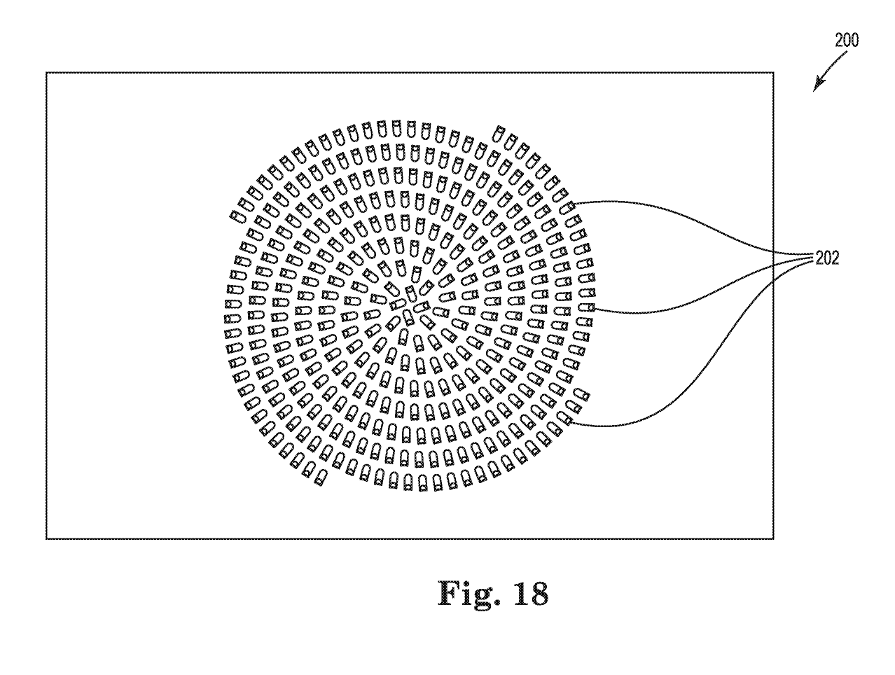

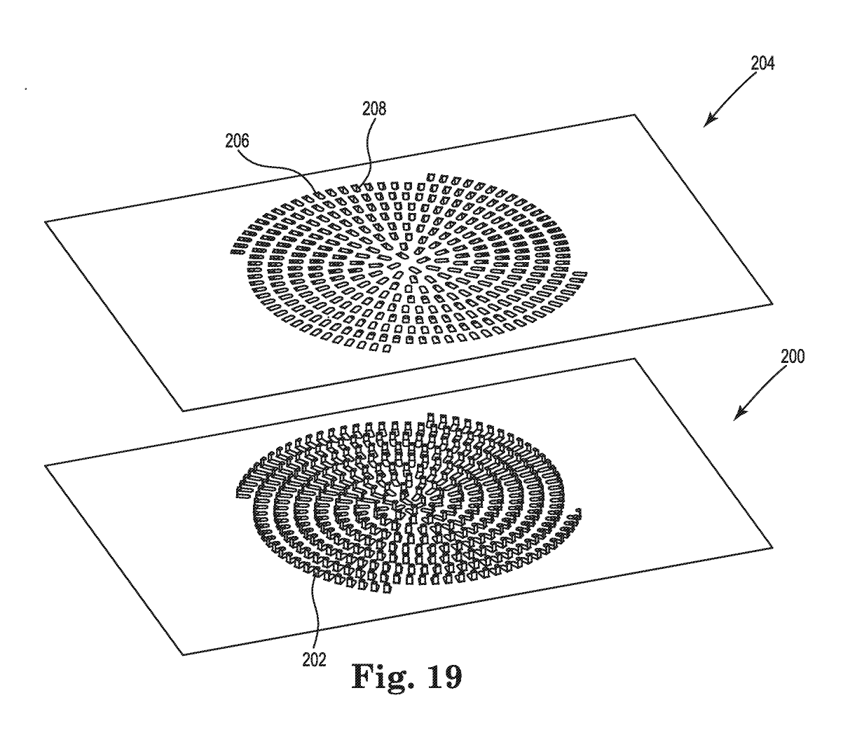

For example, FIGS. 18 and 19 show a bottom skin including connecting elements 202 and corresponding intermediate skin 204 including connecting elements 206 in which the connecting elements are deployed along curves with a generally involute shape that generally spiral outward with increasing radius from the common reference site central to the curves. Using this deployment method, the connecting elements 202 and 206 are positioned along at least one involute curve. To form a composite mirror panel assembly, connecting elements 206 project downward from the intermediate skin 204 to couple skin 204 to skin 200 in spaced apart fashion to define a core region (not shown) between the skins. Connecting elements 202 would then project from bottom skin 200 upward and above intermediate skin 204 through openings 208. A top skin with a reflective top surface (not shown) would then attach to connecting elements 202 in spaced apart fashion above intermediate skin 204 to form the composite mirror panel assembly

Using involute curves to lay out and deploy connecting elements provides many advantages. The shape of the involute curve, the number of curves, and the spacing of connecting elements along the curves provide flexibility to tune the arrangement of the connecting elements to meet the desired composite panel requirements. A characteristic of connecting elements arranged along an involute curve is that each element on that curve is located at a different radial distance from the central reference site. In other words, looking at a single involute curve, a circle centered at the reference site will only cross through the involute curve at a single location. The involute arrangement tends to randomize the connecting element locations such that the bending stiffness characteristics of the composite panel may be improved. The involute layout approach provides a convenient method for laying out the connecting elements in a regular pattern while meeting the functional requirements of a composite sandwich panel.

Other deployment strategies may be employed with respect to the placement of the connecting elements in the practice of the present invention. Examples of some such strategies are discussed in Assignee's Co-pending U.S. patent application titled COMPOSITE SANDWICH MIRROR PANEL USEFUL IN CONCENTRATED SOLAR POWER SYSTEMS, having Attorney Docket Number SLR0008/P1, filed Apr. 28, 2015 (filed concurrently herewith) in the name of Gregory et al.

The present invention further provides strategies for attaching the composite mirror assemblies to other heliostat components. The strategies are useful both for large heliostats that use many individual mirror facets attached to a common frame, as well as on smaller heliostats that have a single mirror facet assembly.

In some heliostat designs multiple mirror panel assemblies are mounted to a common base structure. In turn, that base structure is attached to a common drive mechanism that articulates a plurality of mirror panels around two axes in order to track the sun and redirect sunlight onto a desired target. In this type of layout, multiple, distributed mounting points connect each mirror panel assembly to the underlying heliostat structure. In many instances this is accomplished such that the mirror panel assemblies plus the structure form a rigid assembly. This approach is what is typically done for larger heliostats.

Attaching composite panels to a large heliostat could be problematic if the common frame structure and back skin of the panel are made from different materials. This could cause slope errors due to differential thermal expansion. One way to remedy this is to provide compliance in the attachment points between the heliostat structure and the composite panel. Another approach is to make the back skin of the composite panel from the same material as the coupling structure.

The mounting features between the common frame structure and a panel could take the form of threaded rods, folded sheet metal tabs, or any convenient attachment methods. The attachment of the mounting features to the back of the panel could be achieved with the use of hardware, adhesive, welding, or other fastening method. The mounting features also may be integral with the composite mirror panel as described below.

Another heliostat approach uses a dedicated drive mechanism for each mirror panel assembly. In this arrangement the mirror panel assembly may be self-supporting, since it is typically attached to the mechanism near its center with its edges overhanging the drive. This is similar to a cantilever beam structure. This is the approach typically used for small heliostats.

For small heliostats, the attachment interface typically takes place between a rotational output shaft on the heliostat and the rigid backing structure that supports the reflector. The most common attachment method uses standard hardware, such as nuts or bolts, which allow convenient installation and removal of the facet assembly.

The composite mirror panel assembly of the present invention benefits from being attached to a small heliostat drive with additional, added features. One preferred approach to attachment is to add a folded sheet metal component to the back skin of the composite panel. The component contains mounting features that interface with mating components on the heliostat output shaft. Connection of the folded sheet metal component to the panel skin could be achieved with adhesive, spot welding, screws, or any number of other fastening methods. If the back skin of the composite panel and the heliostat output shaft are made from different materials, it may be preferable to limit the rigid attachment between the two sub-assemblies to a single location, to help mitigate the effects of differential thermal expansion.

It may also be feasible to create attachment features from the back skin of the composite panel itself. Such integral features could be stamped or formed into the sheet at the same time that the connecting elements are created, if desired. This approach is shown in Assignee's Co-pending U.S. patent application titled COMPOSITE SANDWICH MIRROR PANEL USEFUL IN CONCENTRATED SOLAR POWER SYSTEMS, having Attorney Docket Number SLR0008/P1, filed Apr. 28, 2015 (filed concurrently herewith) in the names of Gregory et al.

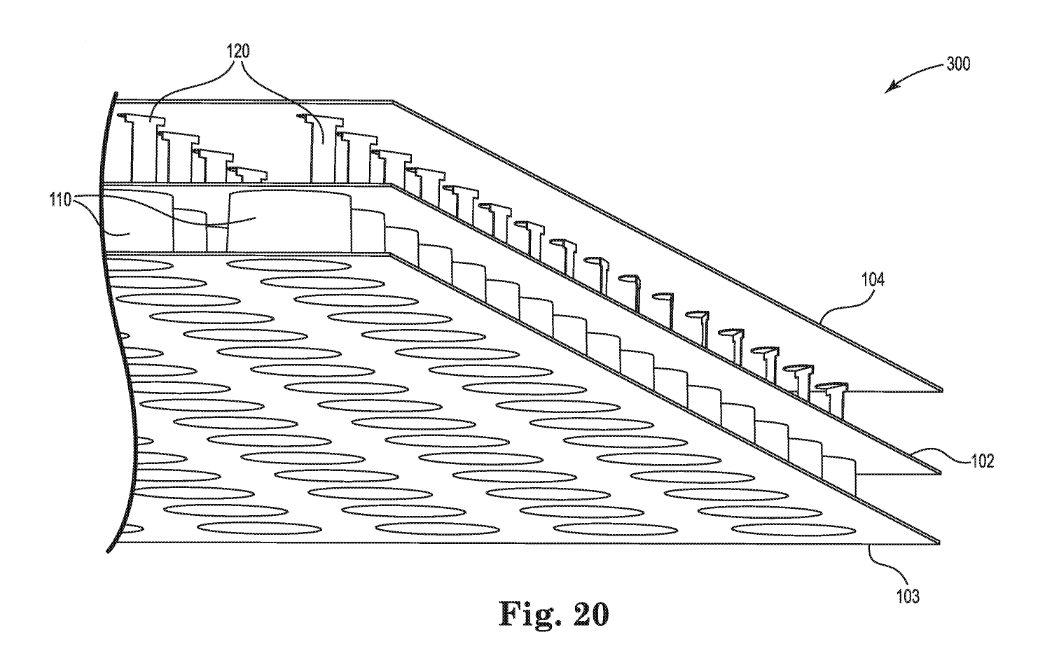

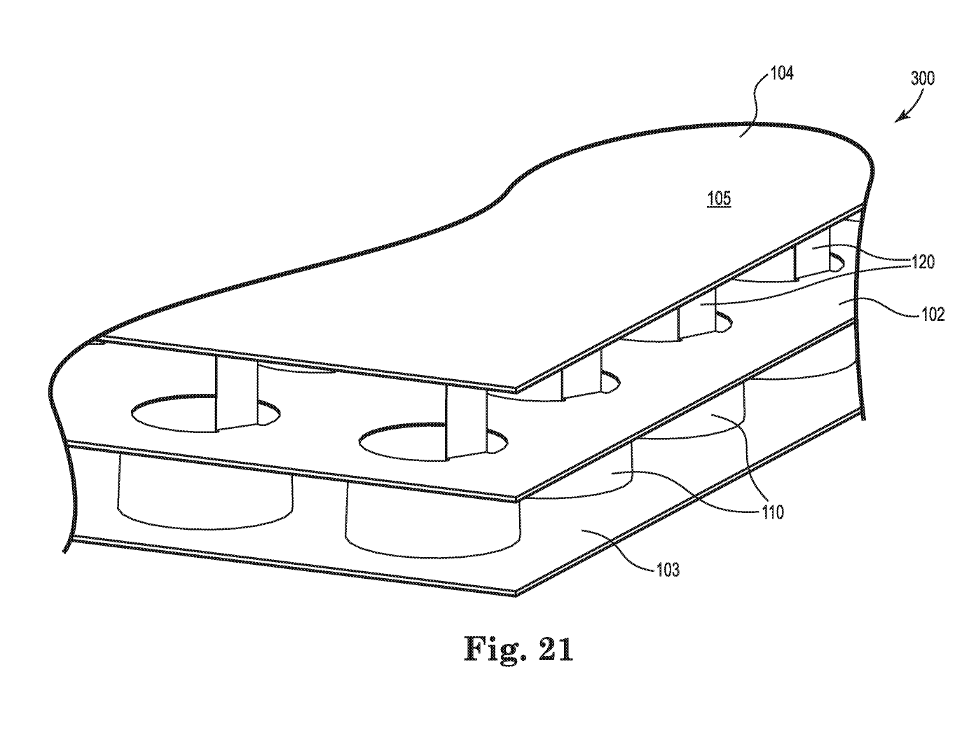

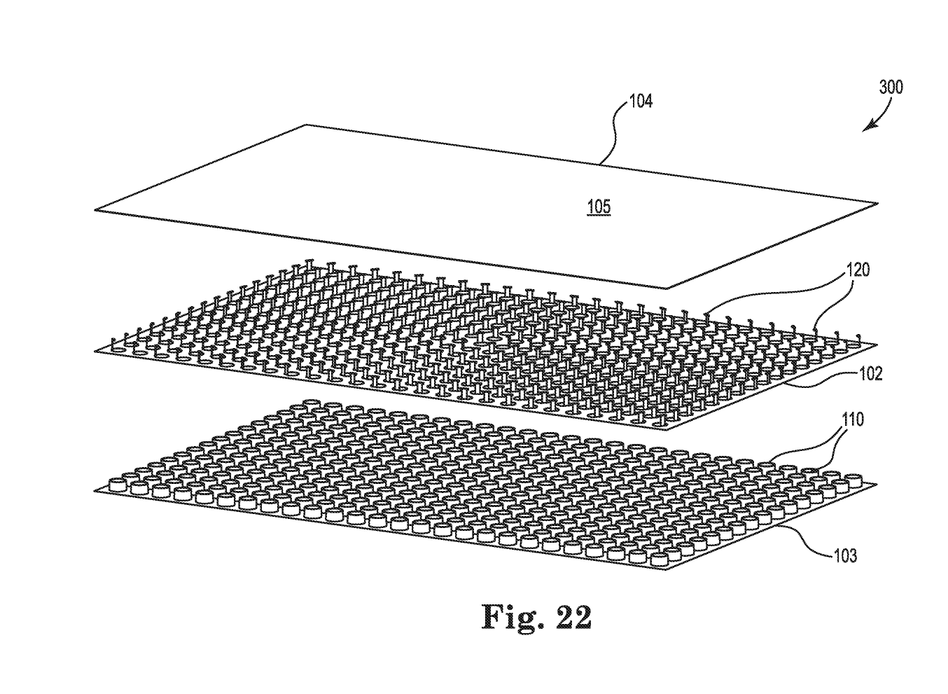

FIGS. 9-11 above show an embodiment of a composite mirror panel assembly 100 incorporating components 102 as a bottom skin with integral connecting elements 120 that attach to the top panel 104. Assembly 100 of FIGS. 9-11 also includes an intermediate skin 103 with integral cylindrical connecting elements 110 that couple skin 103 to skin 102. FIGS. 20 to 22 show an alternative embodiment of a composite mirror panel assembly 300 that can be made using these same components assembled in an alternative manner. As shown in FIGS. 20-22, assembly 300 is provided by using skin 103 as the bottom skin of assembly. Skin 102 is used as an intermediate skin. The cylindrical connecting elements 110 are integrally formed with skin 103 and are coupled to intermediate skin 102. Skin 102, skin 103, and elements 110 form a stiff, structural support structure to which the top panel 104 is flexibly attached. Flexible connecting elements 120 are integrally formed with skin 102 and are attached to panel 104 so that panel 104 is in a spaced apart relationship with skin 102.

In FIGS. 20-22, as a consequence, top panel 104 is coupled to the intermediate skin via connecting elements 120. In contrast, in FIGS. 9-11, top panel 104 is coupled to the bottom skin via connecting elements 120 that pass through the intermediate skin.

All patents, patent applications, and publications cited herein are incorporated by reference in their respective entireties for all purposes. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A light reflecting device that re-directs light at a target, said light reflecting device comprising:
(a) a supporting substrate structure comprising a first skin, a second skin, and a core region that physically couples the first skin to the second skin;
(b) a light reflecting panel comprising a light reflecting surface; and
(c) a plurality of flexible connecting elements that couple the light reflecting panel to the supporting substrate structure in a manner such that the light reflecting panel is spaced apart from the substrate structure.

2-4. (canceled)

5. A light reflecting device comprising:
(a) a bottom skin comprising first and second opposed major faces;
(b) an intermediate skin having first and second opposed major faces and that is spaced apart from the bottom skin, wherein the first major face of the intermediate skin faces toward the bottom skin and the second major face of the intermediate skin faces away from the bottom skin, and wherein the intermediate skin comprises a plurality of openings providing egress through the intermediate skin;
(c) a top panel having first and second opposed, major faces, wherein the top panel is spaced apart from the bottom skin and the intermediate skin, wherein the first major face of the top panel faces toward the bottom skin and the intermediate skin and the second major face of the top panel comprises a reflective surface facing away from the bottom skin and the intermediate skin;
(d) a first core region coupling the intermediate skin to the bottom skin; and
(e) a plurality of flexible connecting elements independently coupling the top panel to at least one of the bottom and intermediate skins, wherein the flexible connecting elements pass through the openings of the intermediate skin to couple the bottom skin to the top panel.

6. A heliostat comprising an articulating light reflecting assembly, wherein the light reflecting assembly comprises:
(a) a bottom skin comprising first and second opposed major faces;
(b) an intermediate skin having first and second opposed major faces and that is spaced apart from the bottom skin, wherein the first major face of the intermediate skin faces toward the bottom skin and the second major face of the intermediate skin faces away from the bottom skin, and wherein the intermediate skin comprises a plurality of openings providing egress through the intermediate skin;
(c) a top panel having first and second opposed, major faces, wherein the top panel is spaced apart from the bottom skin and the intermediate skin, and wherein the first major face of the top panel faces toward the bottom skin and the intermediate skin and the second major face of the top panel comprises a reflective surface facing away from the bottom skin and the intermediate skin; and
(d) a core region that couples the intermediate skin to the bottom skin; and
(e) a plurality of flexible connecting elements coupling at least one of the bottom skin and the intermediate skin to the top panel.

7. A concentrating solar power system, comprising:
(a) a central target; and
(b) a plurality of heliostats that reflect and concentrate sunlight onto the central target, wherein at least one of the heliostats comprises a light reflecting assembly comprising:
(i) a bottom skin comprising first and second opposed major faces;
(ii) an intermediate skin having first and second opposed major faces and that is spaced apart from the bottom skin, wherein the first major face of the intermediate skin faces toward the bottom skin and the second major face of the intermediate skin faces away from the bottom skin, and wherein the intermediate skin comprises a plurality of openings providing egress through the intermediate skin;
(iii) a top panel having first and second opposed, major faces, wherein the top panel is spaced apart from the bottom skin and the intermediate skin, and wherein the first major face of the top panel faces toward the bottom skin and the intermediate skin and the second major face of the top panel comprises a reflective surface facing away from the bottom skin and the intermediate skin; and
(iv) a core region coupling the intermediate skin to the bottom skin; and
(v) a plurality of flexible connecting elements coupling the top panel to at least one of the bottom skin and the intermediate skin, wherein the flexible connecting elements pass through the openings of the intermediate skin to couple the bottom skin to the top panel.

8. The device of claim 5, wherein the core region is integral to the bottom skin and wherein the flexible connecting elements pass through the openings in the intermediate skin.

9. The device of claim 5, wherein the flexible connecting elements pass through the openings in the intermediate skin when coupling the top panel to the bottom skin.

10. The device of claim 5, wherein the flexible connecting element couples the intermediate skin to the bottom skin.

11. The device of claim 5, wherein the flexible connecting elements do not touch the intermediate skin when the flexible connecting elements are flexed

12. The device of claim 5, wherein the connecting elements couple the bottom skin to the top panel in a spaced apart fashion relative to the bottom skin and the intermediate skin.

13. The device of claim 12, wherein the top panel is suspended away and is physically de-coupled from the intermediate skin.

14. The device of claim 5, wherein the connecting elements are integrally formed from a corresponding portion of the intermediate skin.

15. The device of claim 5, wherein the connecting elements are integrally formed from a corresponding portion of the bottom skin.

16. The device of claim 5, wherein the connecting elements are deployed in a rectangular grid.

17. The device of claim 5, wherein the connecting elements are radially aligned relative to a central region of the bottom skin.

18. The device of claim 5, further comprising connecting elements that are generally cylindrical and that couple the bottom skin to the top panel.

19. The device of claim 18, wherein the connecting elements pass through the cylindrical connecting elements to couple the bottom skin to the top panel.

20. The device of claim 18, further comprising corresponding pathways provided through the cylindrical connecting elements and the intermediate skin, wherein the pathway provides portals through which the top panel is coupled to the bottom skin by the flexible connecting elements that pass through the cylindrical connecting elements.

21. The device of claim 5, wherein at least one tab is formed at an end of the flexible connecting elements by folding over a body at a bending line of the connecting elements.

22. The device of claim 5, wherein the flexible connecting elements are arranged in a radial alignment relative to a central region of the bottom skin.

23. The device of claim 5, wherein the intermediate skin comprises aluminum.

24. The device of claim 5, wherein the bottom skin comprises aluminum.

25. The device of claim 5, wherein the top panel comprises a reflective sheet comprising polished aluminum or a float glass mirror.

26. (canceled)

27. The device of claim 5, wherein the core connecting the bottom skin to the intermediate skin comprises apertures extending through the core and the intermediate skin comprises an array of holes, wherein the core is coupled to the intermediate skin so that the apertures and the holes align.

28. The device of claim 5, further comprising a perimeter skirt extending from the bottom skin.

29. (canceled)

30. A method of making a heliostat, comprising the steps of:
(a) providing a light reflecting assembly, comprising the steps of:
(i) providing a bottom skin having a bottom surface and a top surface;
(ii) providing an intermediate skin having a bottom surface and a top surface and a plurality of openings therein to provide egress through the intermediate skin; and
(iii) providing a top panel having a bottom surface and a reflective top surface;
(iv) providing a core region that couples the bottom skin to the intermediate skin in a spaced apart fashion;
(v) providing a plurality of flexible connecting elements that couple the bottom skin to the top panel, wherein the connecting elements pass through the openings in the intermediate skin; and
(b) mounting the light reflecting assembly onto a support structure in a manner such that the light reflecting element articulates to track the sun and re-direct sunlight onto a target.

31. The method of claim 30, wherein the first skin comprises aluminum.

32. The method of claim 30, wherein the second skin comprises a reflective sheet comprising polished aluminum or a float glass mirror.

33. The method of claim 30, wherein the plurality of connecting elements couple the first skin to the second skin in a spaced apart fashion to form the core region.
